(19) United States
(12) Patent Application Publication
(10) Pub. No.: US 2003/0135403 A1
(43) Pub. Date: Jul. 17, 2003

(54) Method for tracking future support engineering requests

(76) Inventors: Gary M. Sanderson, Melbourne, FL (US); Jose Q. Saavedra, Titusville, FL (US); James B. Swank, Melbourne, FL (US)

Correspondence Address: Bruce B. Brunda, Suite 250, 75 Enterprise, Aliso Viejo, CA, 92656, US

(21) Appl. No.: 10/051,560

(22) Filed: Jan. 17, 2002

(51) Int. Cl. G06F 17/60

(52) U.S. Cl. 705/8

(57) ABSTRACT

A method for processing work requests in a system having a central computer with a web server and other pieces of commercial software and a plurality of remote computer workstations coupled to the central computer is disclosed. The method includes, at a first of the remote computer workstations creating a work request and transmitting it to a first level for approval. The first level reviews the work request and, if approved, transmits it to a second level for approval. The second level reviews the work request and, if approved, transmits it to a third level for assignment for work. A Facilitator works the request and provides a final response. Upon completion by the Facilitator, and if approved by a third level Group Lead, the request is transmitted to a fourth level Review Board for approval. If the response is approved, the request is then transmitted to fifth level personnel for final closure. If the response is not approved, the request is transmitted back to the third level Group Lead and Facilitator(s) for further work. The work performed is then reviewed by the fifth level personnel and the request Originator. If the response is satisfactory, the work request (FSER) is closed. If the response is unsatisfactory, the request is transmitted back to the third level Group Lead and Facilitator for further work.

### STATEMENT RE: FEDERALLY SPONSORED RESEARCH/DEVELOPMENT

This invention was made with United States Government support under Contract No. F09603-96-C-0005 awarded by the U.S. Air Force, Robins Air Force Base, Warner Robins, Ga. The United States Government has certain rights in this invention.

### CROSS-REFERENCE TO RELATED APPLICATIONS

(Not Applicable)

### BACKGROUND OF THE INVENTION

The present invention relates to the field of tracking and processing work requests and, in particular, to an automated system and method for processing, tracking and recording Future Support Engineering Requests (FSER's).

Traditionally, work requests were processed manually and typically took an inordinate amount of time between the original request and final completion or closure. Moreover, the person who made the original request never was informed of or could not easily discover the status of the request during the approval cycle. This prior art system is very inefficient and costly.

In the recent past, whenever an engineer made a request for technical support, a paper process was begun, which progressed along an approval cycle from one individual to the next. The request could be delayed anywhere along the approval cycle, and the original requester would not know the status of their request or if there were any problems that needed to be addressed.

Accordingly, it is desirable to automate a request/approval/work/validation cycle and to make the process paperless and run smoother and more rapidly. Thus, by using one of today's modern computing systems, in this case an intranet, it is possible to satisfy this need.

Moreover, it is desirable to provide an automated and rapid means for the Originator of a work request to discover the status of his request.

### BRIEF SUMMARY OF THE INVENTION

It is therefore a feature of the present invention to provide an automated web based system that simplifies the process for requesting, approving, working and validating engineering requests. Work assignments and status reporting notifications are managed via email and any readily available web browser application.

Another feature of the present invention is the provision of an automated paperless web based system. Online documentation including pictures may be attached to an FSER during different steps of the process. Also, online help is available on all FSER web pages. All user actions include a date, time and name of the Originator.

Still another feature of the present invention is the provision of online feedback via email to all authorized users of the process and, in particular, it allows the Originator to remain informed by means of email and FSER Reports of all actions on their request (i.e., the FSER).

Yet another feature of the present invention is the provision of a permanent record of all documented actions thereon.

Another feature of the present invention is the provision of a process whereby any employee with intranet access may view (via their web browser) the progress and status of an FSER throughout the review, work and approval process, as well as after the FSER has been closed.

These and other features, which will become apparent as the invention is described in detail below, are provided by a method for processing requests for engineering support in a system having a web server, along with other commercial off-the-shelf software, on a central computer and a plurality of remote work stations coupled to the central computer via an intranet. The method begins at any workstation on the intranet by an Originator creating a draft engineering request and submitting it to the first level of support for approval. The personnel assigned first level responsibility review the request and, if deemed appropriate, approve the request. The request is next assigned an FSER number that is retained with the request from this point forward. The request is then automatically forwarded via email to the second level of support for approval. The second level (Review Board) reviews the request and, if deemed appropriate in scope and in budget, approves the request. The request is then forwarded to the appropriate third level of support (Group Lead) to be assigned for work. The third level personnel assign the request to Facilitator(s).

The Facilitator(s) work the request, provide periodic status and, when the request is completed, provide a final response to the request. Upon submittal of the final response, the request is forwarded back to the Group Lead (third level) for further review. If the final response is determined to be acceptable by the Group Lead, the request is then sent to level four personnel (Review Board). If the final response is determined to be acceptable by the Review Board, the request is next forwarded to level five personnel for final review and approval. Level five includes the Originator. This allows the person identifying the problem the opportunity to ensure the final response satisfies the original request. Once Level 5 personnel deem the request is answered satisfactorily, the FSER is closed. Throughout this process, each level has the opportunity to reject a request or final response, at which point the FSER is rerouted for further actions. It is noted that the FSER Originator (along with all persons with access to the intranet) can view the request at any time during the FSER cycle via FSER Reports.

In an alternate embodiment of the present invention, the first level personnel may reject the work request. Upon rejection, the Originator is informed by email of the rejection and the work request is cancelled before it is assigned an FSER number. The Originator has the option of revising and resubmitting the request to Level 1 personnel for reconsideration.

In another embodiment of the present invention, if the Review Board at Level 2 rejects the request (for any number of possible reasons), the Originator and the Level 1 personnel are automatically informed via email. The request is then closed and an annotation is made on the FSER stating that the Level 2 personnel rejected the request.

In still another embodiment of the present invention, if the FSER final response is unsatisfactory, the Facilitator(s) rework the request until the final response is approved by the Group Lead (Level 3), Level 4 and Level 5 personnel.

In still another embodiment of the present invention, all persons having access to the intranet may review the information provided in all FSERs in the system via the web page in the form of a report. Draft requests (prior to Level 1 approval) have limited visibility.

Still other features and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims.

### BRIEF DESCRIPTION OF THE DRAWINGS

The general purpose of this invention, as well as a preferred mode of use, its objects and advantages will best be understood by reference to the following detailed description of an illustrative embodiment with reference to the accompanying drawings in which like reference numerals designate like parts throughout the figures thereof, wherein:

FIG. 1 is a general block diagram of a computer system, network and intranet useful for implementing the method of the present invention.

FIG. 2 is a block diagram of the process flow for processing a Future Support Engineering Request (FSER), which also represents the Main Menu of the invention.

FIGS. 3A, 3B and 3C combined form a flow chart of the method of the present invention.

FIG. 4 is a diagram of a screen view depicted for generation of a FSER by an Originator.

FIG. 5 is a diagram of a screen view depicted for Level 1 personnel review of a FSER.

FIGS. 6A and 6B combined form illustrate a screen view depicted for Level 2 personnel review of a FSER.

FIG. 7 is a diagram of a screen view depicted for Level 3 personnel review of a FSER and Facilitator assignment.

FIGS. 8A and 8B combined illustrate a screen view depicted for providing Status and Final Response to a FSER.

FIGS. 9A and 9B combined illustrate a screen view depicted for Level 4 review of a FSER.

FIGS. 10A and 10B illustrate a screen view depicted for Level 5 review of a FSER.

FIG. 11 is a diagram showing the interaction between the central computer 10 software and the Web Browser software on each of the PC's 11 through 14. (Ref. FIG. 1)

### DETAILED DESCRIPTION OF THE INVENTION

Briefly stated, the process begins with an Originator who generates a draft FSER. Next, the draft FSER is routed to first level personnel, who approve or reject the FSER. If the FSER is rejected, the system automatically notifies the Originator by an email. The Originator has the option of revising and resubmitting the request to Level 1 personnel for reconsideration. On the other hand, if the FSER is approved, it is assigned an FSER unique number and routed to the Level 2 personnel (Review Board). If disapproved at level 2, the FSER is closed and the Originator is notified by email. If approved at Level 2, the FSER is assigned to a specific Group for work, or processing. The Group Lead (Level 3) then assigns a suspense date, job charge and Facilitator(s) to handle and process the FSER. An email is automatically sent to the Facilitator(s) to indicate that they are to begin work on the request. Additionally, the Originator is automatically notified by email that their request (FSER) is being processed. While the FSER is in the process of being worked, the Facilitator(s) provide periodic status on their actions to answer the request. When the work is completed, the Facilitator(s) provide a final response on the FSER web form. This action causes an email to be sent to the Group Lead (Level 3) indicating that their review of the Facilitator's final response is required. If the Group Lead rejects the Facilitator's final response, the Facilitator is notified that further work is required. If the Group Lead approves the Facilitator's final response, an email is automatically sent to the level four personnel indicating that their review is required. Upon rejection by the Review Board at level four, an email is routed to the Facilitator and Group Lead indicating further work is required. On the other hand, upon approval by level four personnel, an email is routed to level five personnel indicating that their review is required. Level five personnel include the Originator. Upon rejection by level five, an email is routed to the Facilitator and Group Lead indicating further work is required. On the other hand, upon approval by level five personnel, the FSER is closed and no further action is required.

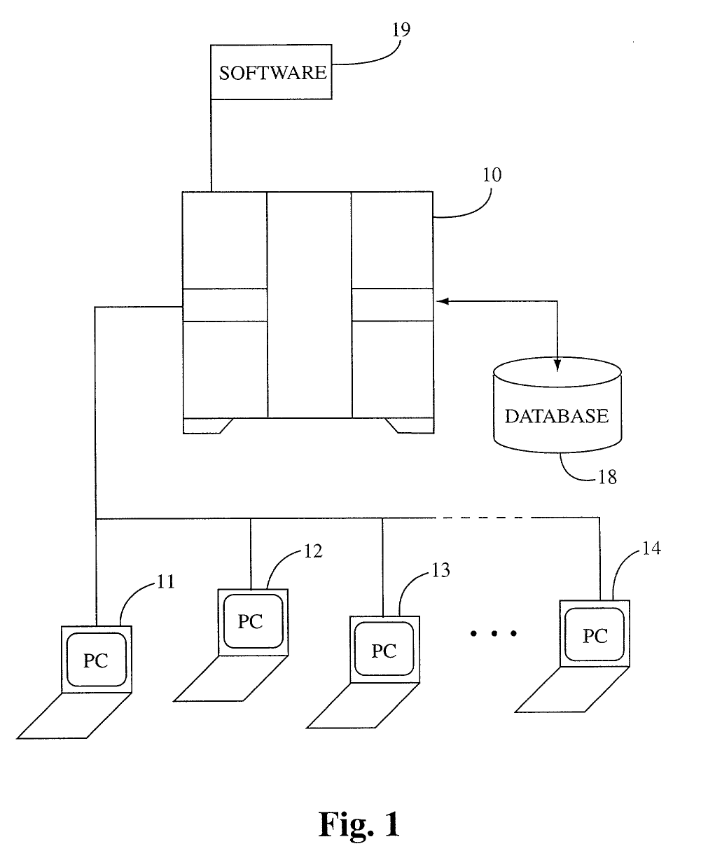

Referring now to the drawings and FIG. 1 in particular, a computer system and intranet useful for implementing the method of the present invention is shown. A central computer 10 running a web server and other commercial off-the-shelf software has coupled to it workstations 11, 12, 13, 14, which communicate directly with the central computer 10. A database 18 is accessible by the computer 10 and contains data pertinent to the FSER process. The computer 10 executes a variety of software, including commercial software 19, which is useful for implementation of the process of the present invention. Software 19 may for instance include:

Web Server (MS IIS or Apache)—Central Computer;

Cold Fusion Server (v4.5 or higher)—Central Computer (Macromedia Corp.);

ODBC Database (MS Access 97)—Central Computer; and

Web Browser (MS IE 5.0 or higher or Netscape 4.0 or higher)—Workstation.

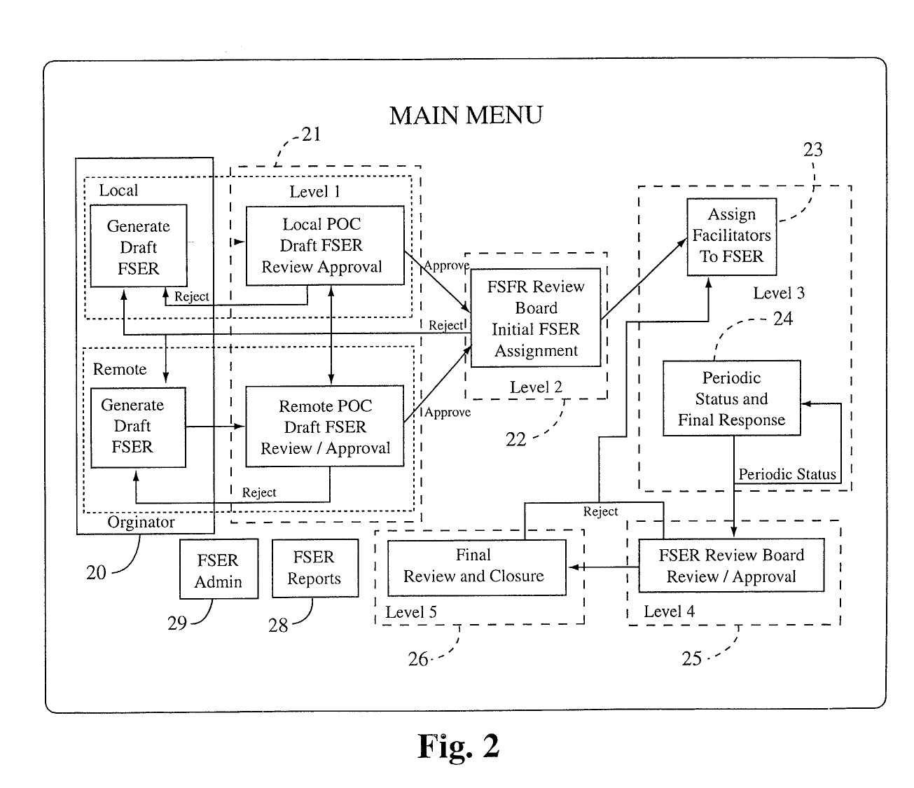

Referring now to FIG. 2, a block diagram of the process flow for processing an FSER is shown. This block diagram is the Main Menu of the process and appears on a user's screen for selection of options as described in greater detail below. The process begins with an Originator 20, who generates a draft FSER and passes it on to Level 1 personnel (block 21). The Originator may either be local or remote. The Originator automatically receives email updates throughout the entire process. Moreover, the Originator 20 may obtain a report on the status of an FSER at any time by accessing the FSER intranet web site. The Level 1 personnel (block 21) review the draft FSER created by the Originator 20 and make changes to it as necessary. The Level 1 personnel (block 21) either approve or reject the draft FSER. If the FSER is rejected it is removed from view by all users on the intranet. The Originator 20 is notified of such action by email. On the other hand, if the FSER is approved, an FSER unique number is assigned to the request and it is forwarded to Level 2 (block 22). An email is sent to the Originator 20 notifying him of this action.

Level 2 (block 22) assigns a Group Lead to the FSER. Next, the Group Lead at level three provides a suspense date, job charge and Facilitator(s) (block 23) to work the request. When the Facilitator(s) (block 23) complete their work, the Group Lead reviews the FSER and forwards it to the Review Board (block 25) at Level 4. An email is sent to the Originator 20 notifying him of this action. The Review Board 25 then reviews and approves the FSER. Finally, the Level 5 personnel review and approve the FSER and the FSER is closed (block 26).

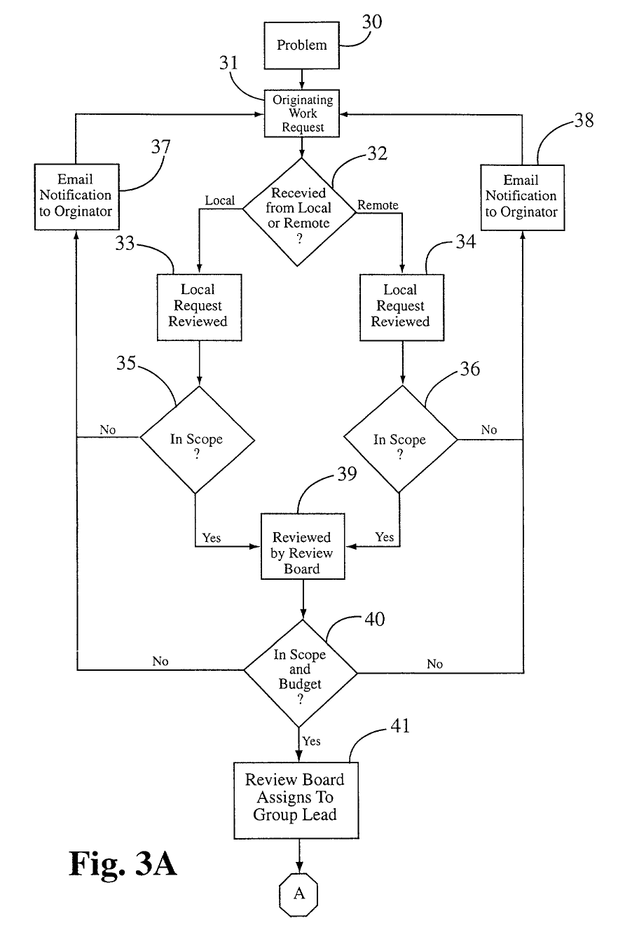

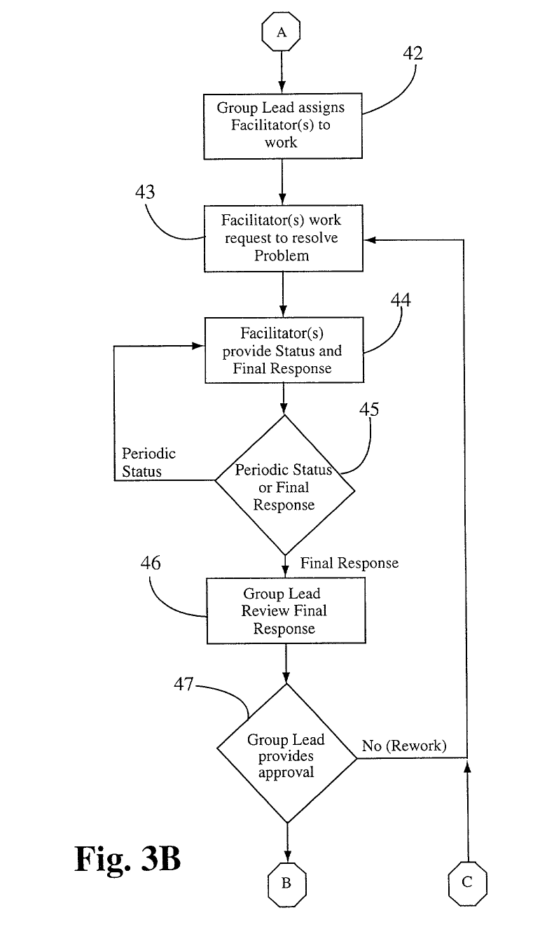

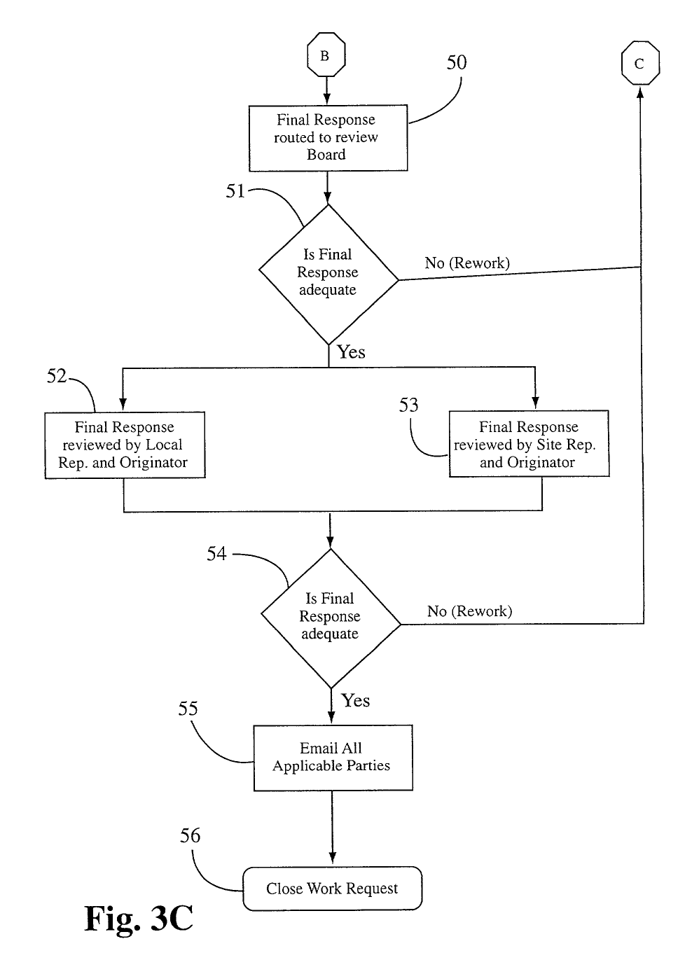

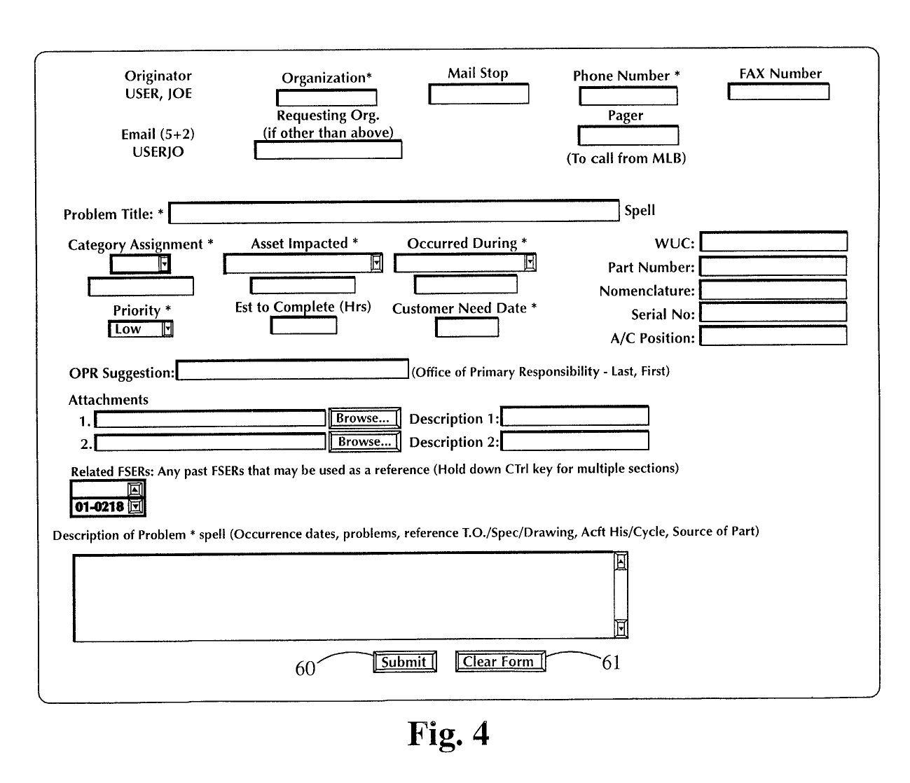

FSER reports 28 are generated dynamically on the fly for any personnel requesting such. An FSER Administrator 29 monitors and coordinates all system communications, maintains data lists, ensures all levels are assigned appropriately and maintains the general integrity of the invention. Accordingly, it has been shown that an FSER is routed through a system that automatically tracks its progress and allows access by anyone on the network. The details of the process are set forth below in conjunction with a description of the flow charts shown in FIGS. 3A, 3B and 3C and the screen diagrams illustrated in FIGS. 4 through 10.

Referring now to FIG. 3A, the first of a three-sheet flow chart of the method of the present invention is shown. The process begins with a step of defining an engineering problem (30). The Originator selects from the FSER main menu on his computer screen for creation of a draft FSER, (see the screen illustrated in FIG. 2). The Originator creates a work request by completing the FSER form presented on the screen (FIG. 4) (31). Once the form has been completed and all required fields have been entered, the Originator selects the “Submit” button and the FSER is submitted (32). A page is then presented on the Originator's computer screen showing all the data that was entered. Also, any attachments to the FSER will be in the form of “hot links”. A hot link is a mechanism for sharing data between two application programs where changes to the data made by one application appear instantly in the other's copy. The Originator must now select the “Submit for Review” button to generate the draft FSER, or select the “Back to Change” button to make modifications.

When the Originator selects the “Submit for Review” button upon completion of the form, the Originator receives an email notification that the FSER has been submitted for Level 1 review, which email contains a link to the draft FSER. Also, an email message is generated and sent to Level 1 personnel instructing them that a draft FSER has been created. This email message contains a hot link to the web page for their action and the contents of the FSER. They may also access this FSER via the Main Menu (see FIG. 2).

After reviewing an FSER by local Level 1 personnel (33) or a remote site Level 1 personnel (34), a determination is made as to whether or not the FSER is within the scope of work (35 or 36, respectively). For high priority FSER's, Alternate personnel at all levels have the capability to perform the necessary action if the Primary person is not available. Additionally, the Level 1 personnel may make changes to the FSER “Problem Description” if necessary to help clarify the problem. If the FSER is not within the scope of work, as determined by the Level 1 personnel, an email notification is sent to the Originator (37 and 38, respectively) and the Draft FSER is removed from the system. The Originator has the option of revising and resubmitting a rewritten Draft FSER request to Level 1 personnel for reconsideration. On the other hand, if the request is within the scope of work and is approved by Level 1 personnel, then it is automatically forwarded to the Level 2 Review Board for processing (39).

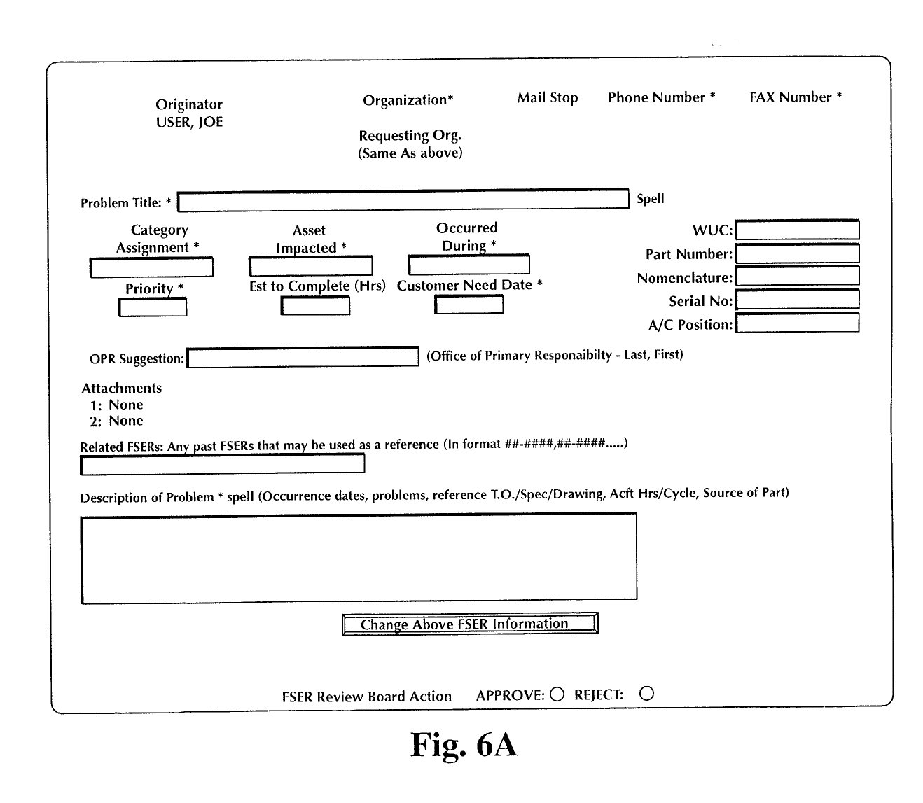

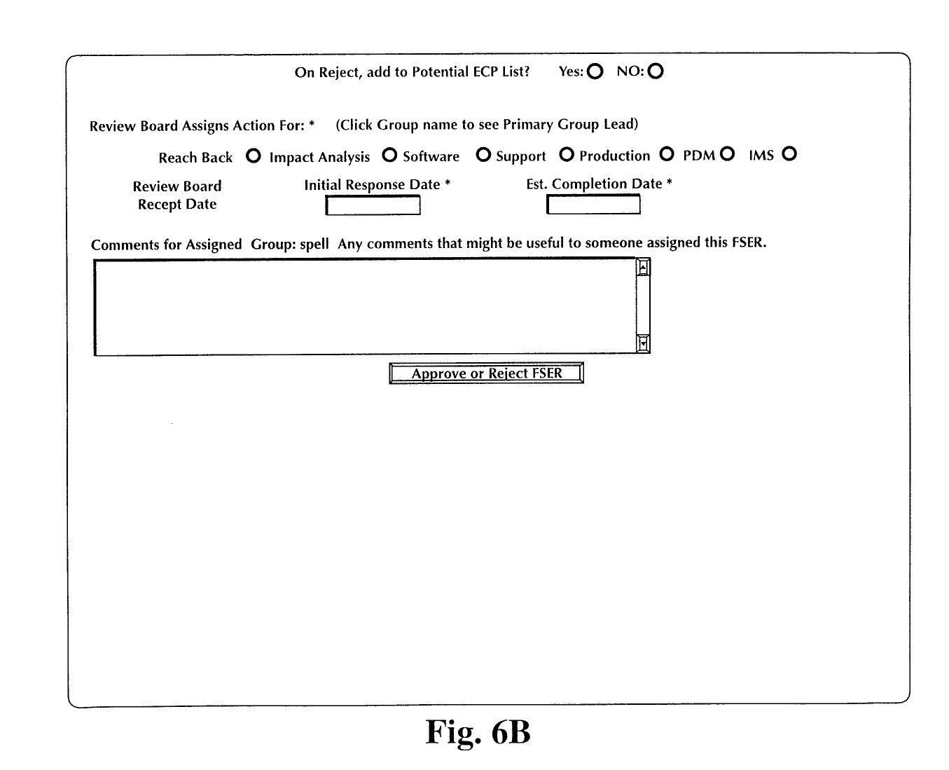

Level 2 personnel receive email notification requesting their action. The Level 2 Board has the authority to modify, approve or reject the FSER. A review by the Board determines if the FSER is within scope and budget (40). Additionally, the Level 2 Board may make changes to the FSER problem description if necessary to help clarify the problem. If the answer to the scope and budget inquiry is no, then an email is automatically sent to the Originator notifying him of this determination (37 and 38), the FSER is closed and no further action is required. FIGS. 6A and 6B depict the screen view for Level 2 personnel who are reviewing an FSER.

If it is determined that the FSER is within scope of work and budget, then it is assigned by the Review Board to a Level 3 Group Lead (41) for work assignment. The Level 3 Group Lead receives an email containing the FSER and indicating that they are to assign the FSER to the required Facilitator(s) for work. After this, the process continues in FIG. 3B as denoted by a connector A.

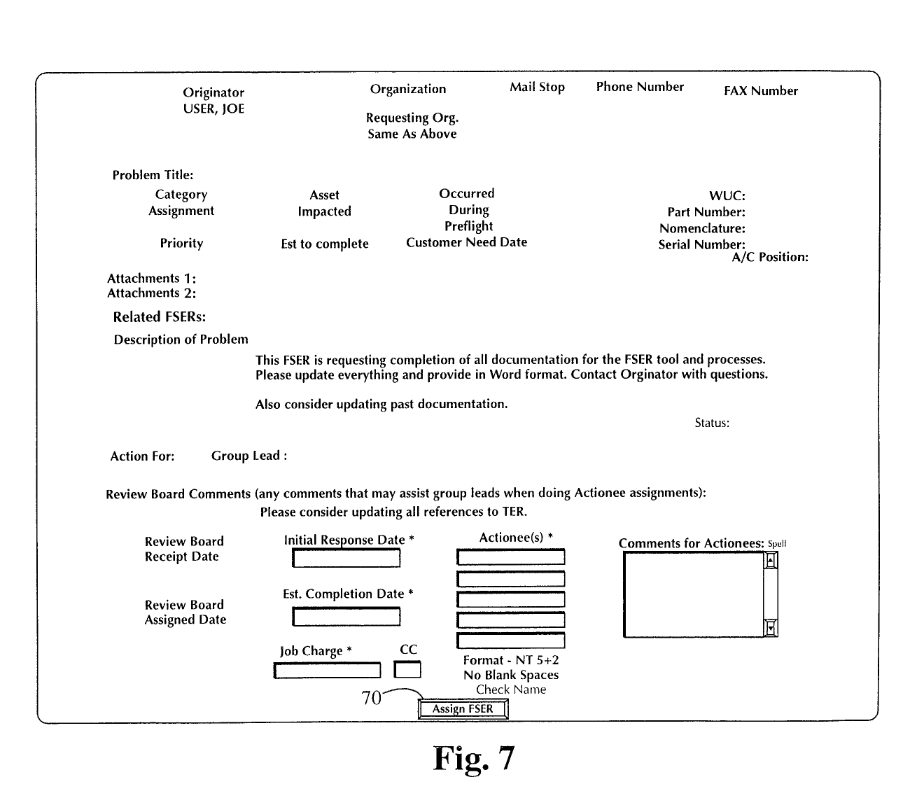

Referring now to FIG. 3B at the connector A, the Level 3 Group Lead (block 42) reviews the FSER to determine the best employee for the work. They provide suspense dates, job charge and a list of Facilitator(s) to work the request. Once the information is provided they enter the information and submit the form. An email notification is sent to all of the Facilitator(s) assigned to work the FSER request. This email contains the FSER information and indicates the actions the Facilitator(s) are to take. FIG. 7 depicts the screen view for Level 3 personnel who are to review an FSER and Facilitator assignment.

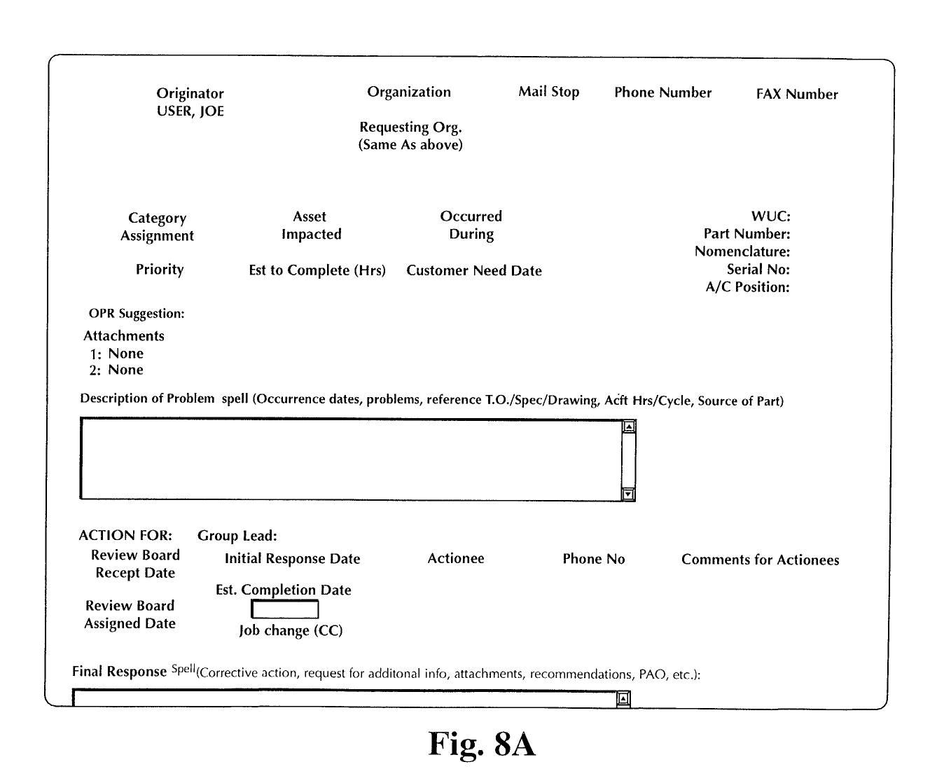

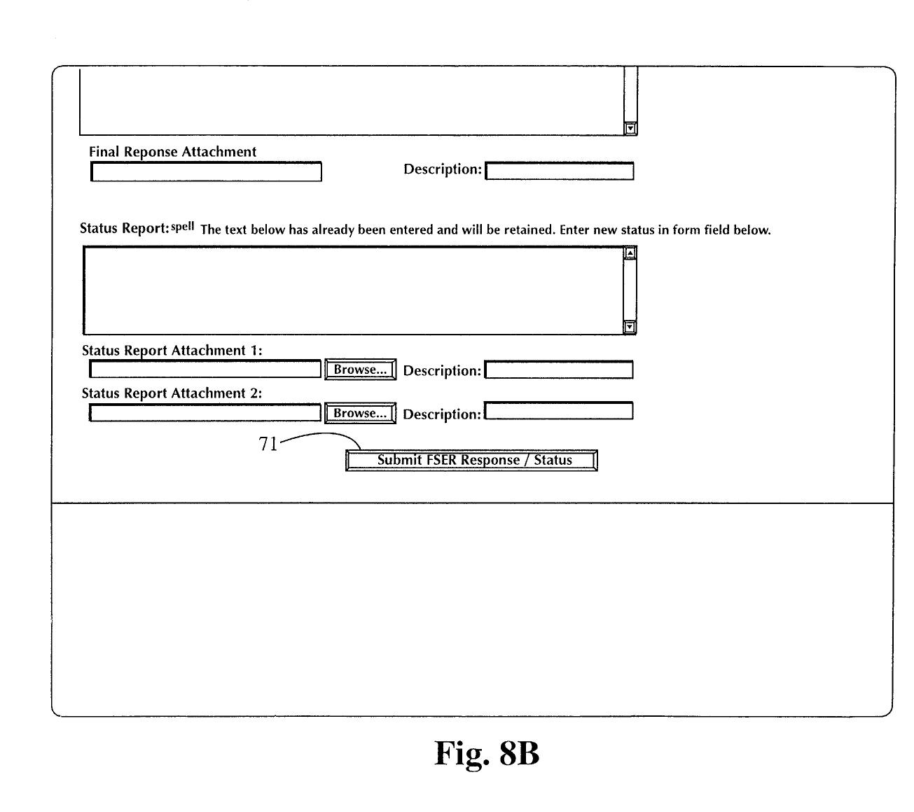

The Facilitator(s) works the FSER request (43). Periodically, the Facilitator(s) provide status (44, 45) on their efforts at resolving the request. The response may be a file attachment to further detail the status. When work on the FSER is complete, the Facilitator(s) provides a final response (45). This is a detailed answer to the FSER request and may contain a file attachment to help clarify the response. Upon submittal of the final response by the Facilitator(s), the Level 3 Group Lead is notified via email to review the final response. This review is to ensure the correctness and completeness of the Facilitator(s) final response. FIG. 8 depicts the screen view for providing status and final response to an FSER.

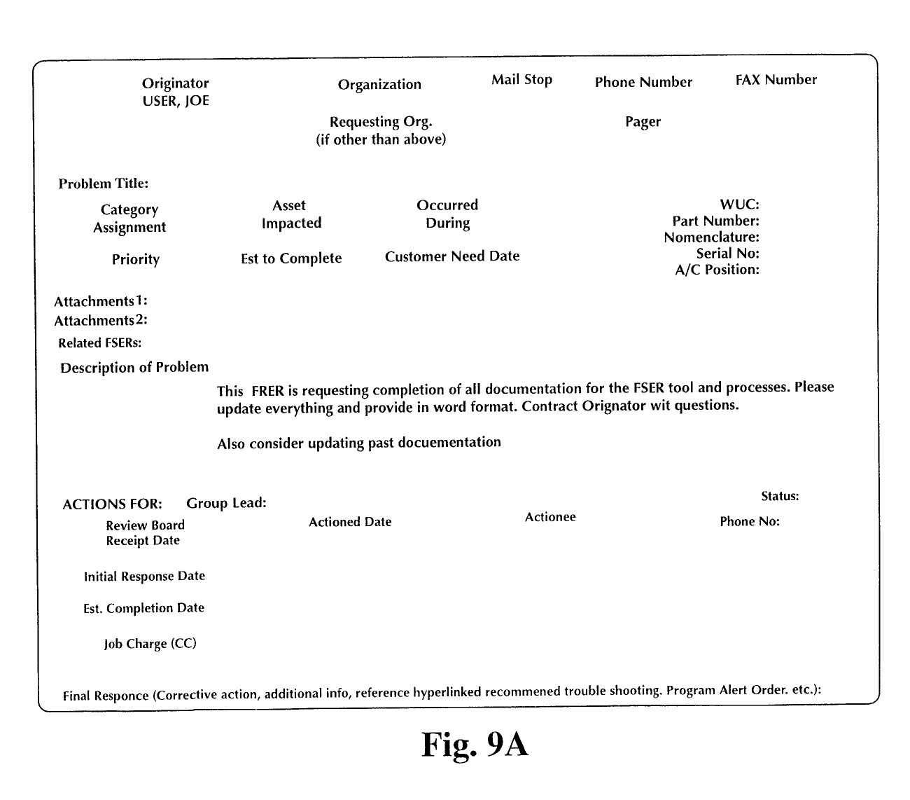

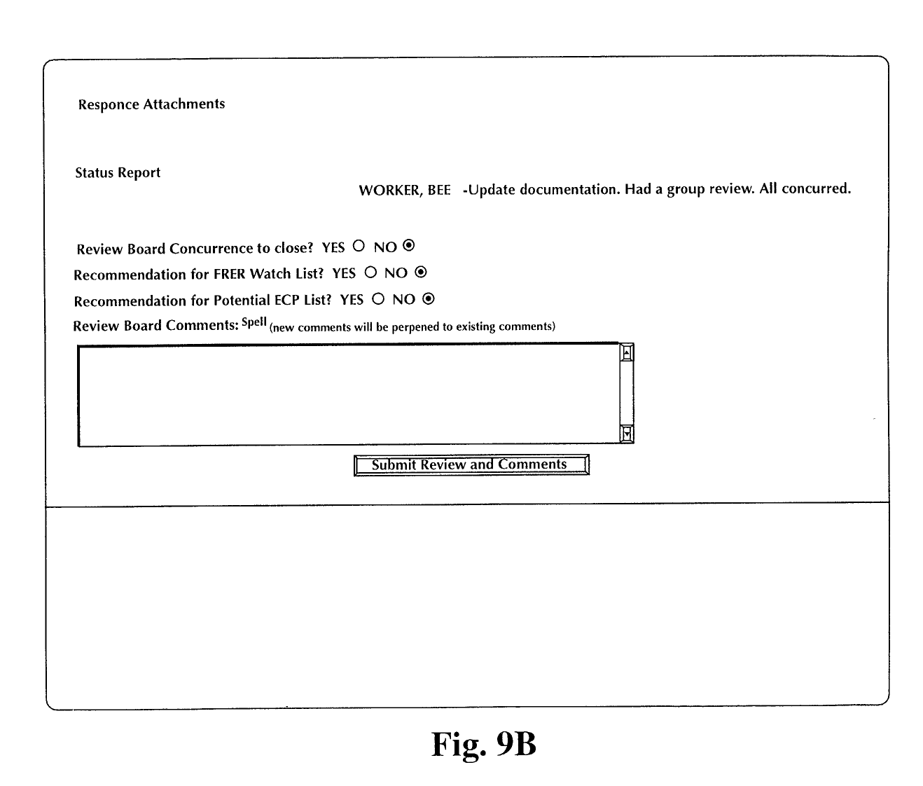

The Level 3 Group Lead reviews the FSER's final response and any attachments (46). If the Level 3 Group Lead does not concur with the final response (47), then he provides rationale for not concurring and forwards the FSER back to the Facilitator(s) for further work (43). The Group Lead may, alternatively, modify the final response and forward the FSER to the Level 4 Review Board. On the other hand, if the Group Lead concurs with the final response (47) provided by the Facilitator(s), the Group Lead then submits the FSER to the Level 4 Review Board. FIGS. 9A and 9B depict the screen view for Level 4 personnel reviewing an FSER. The process illustration continues in FIG. 3C as denoted by a connector B.

Referring now to FIG. 3C at the connector B, the Level 4 Review Board receive an email indicating their review of the final response is required (50). If the Board concurs with the final response (51), they submit the FSER to the Level 5 personnel for final closure. If the Board does not concur with the final response, they provide a rationale for not concurring and submit the FSER back to the Level 3 Group Lead and Facilitator(s) for additional work (FIG. 3B, 43, via connector C).

The Level 5 personnel (including the Originator) receive an email requesting their review of the final response (52, 53). If the Level 5 personnel concur with the final response, they submit the FSER for closure (54). If they do not concur with the final response, they provide rationale for not concurring and submit the FSER back to the Level 3 Group Lead and Facilitator(s) for additional work (FIG. 3B, 43, via connector C).

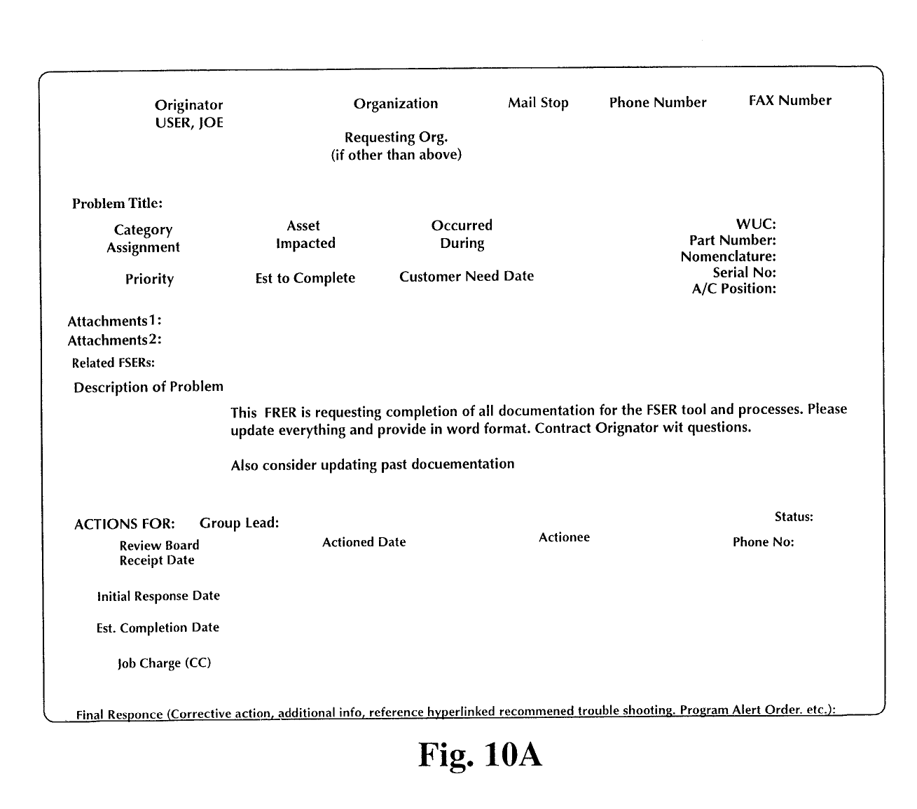

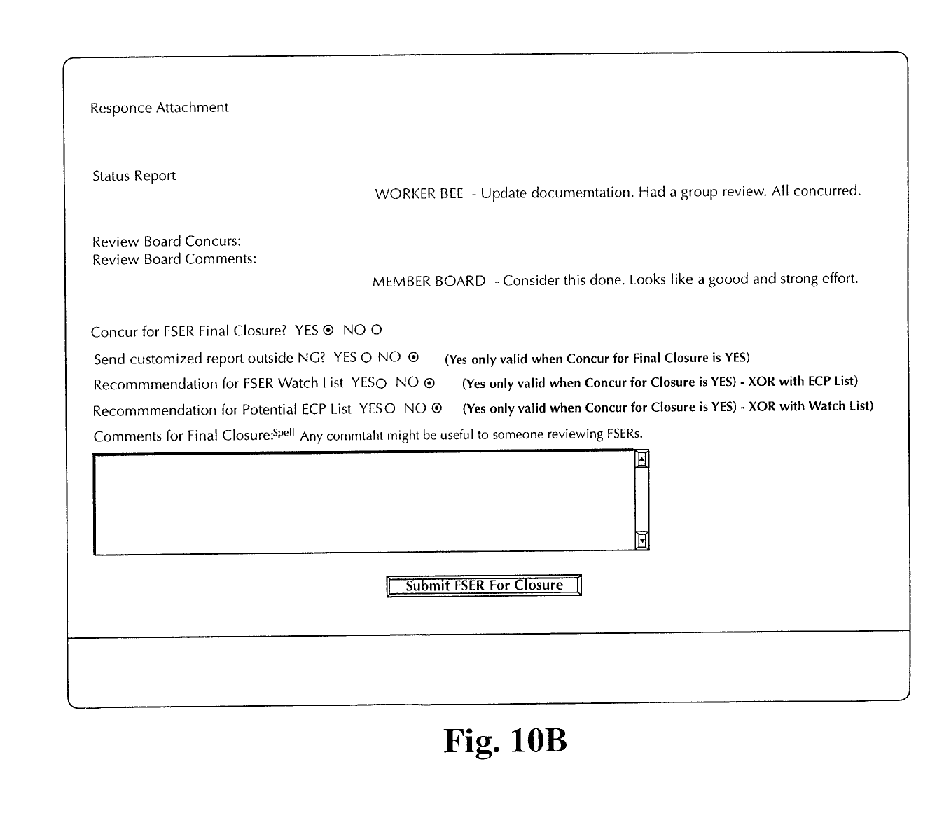

Once the Level 5 personnel concur with the final response (54) provided by the Facilitator(s), the FSER is closed and all personnel are notified via email (55). Once closed (56), no further action can be performed on the FSER (with two exceptions as described below). However, the closed FSER will be available for review via the FSER Reports. FIGS. 10A and 10B depict the screen view for Level 5 personnel reviewing an FSER.

At 47 (FIG. 3B), 51 and 54, a selection can be made to place the FSER on: 1) the FSER Watch List, or 2) the FSER Potential Engineering Change Proposal (ECP) List upon final closure. If the FSER is placed on either of the two lists, personnel assigned a specific level (i.e., level 1 to 5) in the system may provide additional status to the FSER after it is closed. This capability provides a means for continuing to track work related to, but not specifically on, the closed FSER.

At each of the 5 levels there are 3 distinct personnel assignments: Primary, Alternate and Reviewer. Primary personnel at a level receive all email sent out to that level. Primary personnel have total access to all steps in the process for that level. In particular, Primary personnel are expected to expedite FSER requests that are deemed critical in nature. Alternate personnel provide a backup to the Primary personnel at that level. For FSER deemed critical in nature, the Alternate has the same access as the Primary personnel and will receive the same email notifications. For non-critical FSER, the Alternate receives an email that directs them to the FSER report for the FSER in question. They may, however, access the same web pages as the Primary personnel via the Main Menu. Reviewers can take no specific actions in the tool. As a Reviewer they will receive email notifications on actions for the level at which they are a Reviewer. The email notification directs them to the FSER reports for the FSER in question.

FSER Reports provide a means for all employees with access to the intranet to view current FSER status and work. This visibility is the primary impetus for the development of this product. Reports can be generated in a variety of ways including FSER Number, keyword searches, current status and other identifying FSER information.

The FSER tool also provides a robust administration section. Personnel assigned as an Administrator are tasked with overseeing the personnel assigned to the different levels, maintaining the different data lists and ensuring FSER data integrity. Only personnel assigned as an Administrator have access to this area of the FSER tool.

Referring now to FIG. 4, a diagram of a screen view is depicted for generation of an FSER by an Originator. The person requesting the work fills out this form as required, and when complete they select a Submit button 60. This selection initiates the process by which the information provided on the form is uploaded, along with any attachments and updates, to the database 18 (FIG. 1). The Originator may also clear the form by selection of a Clear Form button 61.

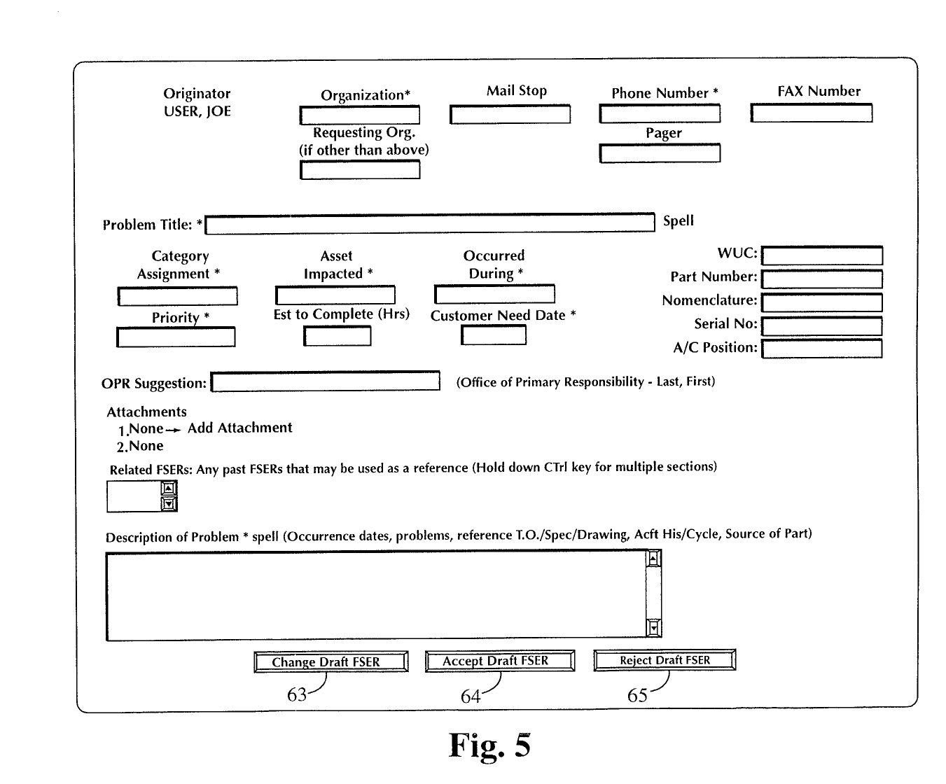

Referring now to FIG. 5, a diagram of a screen view is depicted for Level 1 personnel to review an FSER. This screen is displayed on the Level 1 personnel's PC screen after selection of 21 of the Main Menu (FIG. 2), depending upon whether they are at a local or remote site, respectively. This form may also be accessed by a hot link within an email message received in response to the Originator submitting the request form. Based upon the information provided, the Level 1 person selects a Changes Draft FSER button 63, Accept Draft FSER button 64 or Reject Draft FSER button 65. Selection of any one of these buttons causes the selected action, including updating of the database 18 (FIG. 1).

Referring now to FIGS. 6A and 6B, an illustration of a screen view is depicted for Level 2 personnel to review an FSER. This screen is displayed on the Level 2 personnel's PC screen after selection of 22 of the Main Menu (FIG. 2), and may also be accessed by a hot link within an email message received in response to the Level 1 personnel selecting the Accept Draft FSER button 64 (FIG. 5). This form allows the Level 2 personnel to review the request, make adjustments to the description if necessary, accept or reject the request, assign the request to a group for work and provide proposed response and completion dates. If they choose to reject the FSER (which causes closure) they can place it on the Potential ECP list. On acceptance, the Level 3 Group Lead and the Originator are notified vie email. Any of the actions described above will cause an update of the database 18 (FIG. 1).

Referring now to FIG. 7, a diagram of a screen view is depicted of a form for Level 3 personnel to review an FSER and make Facilitator assignment. This screen is accessible via an email hot link in the previous email or via 23 of the Main Menu (FIG. 2). This form allows the Group Lead to adjust the work completion dates, provide a work job charge number and assign the personnel to work the request. They may also provide additional comments for the Facilitators. Upon submittal of the form by selection of an Assign FSER button 70, the Facilitators are notified via an email that they are to work the request, and the database 18 (FIG. 1) is updated. The Originator is also notified via an email of the names of the individuals to work the request.

Referring now to FIGS. 8A and 8B, a diagram of a screen view is shown depicting the form for providing Status and Final Response to an FSER. This form is accessible via a hot link in the previous email or via 24 of the Main Menu (FIG. 2). This form allows the Facilitators, Group Leads and the Originator the ability to adjust the problem description (if necessary), modify the estimated completion date, provide periodic status text or attachments and provide a final response or attachment. Upon selection of a Submit FSER Response/Status button 71, the form contents and any attachments are uploaded to the server 10, wherein the database 18 (FIG. 1) is updated. If the final response did not change, no email is sent. If the final response did change, the Level 3 Group Lead is notified via an email that their review is required. The Group Lead sees the same form with three extra fields: an accept or reject final response, place the FSER on a Watch List, or place the request on a Potential ECP list. The Level 3 personnel review the final response and accept or reject the FSER. If they accept the final response, they may select to place the request on one of the two lists for further tracking. They may also change the final response to better reflect the position of the company. On rejection, the Originator is notified via an email and the database 18 (FIG. 1) is updated. On acceptance, the Level 4 Review Board personnel are notified via an email that their action is required. The database 18 (FIG. 1) is updated accordingly.

Referring now to FIGS. 9A and 9B, an illustration of a screen view is depicted of the form for Level 4 personnel to review an FSER. This form is accessible by Level 4 personnel via a hot link in the email received in the previous email or from selection of 25 of the Main Menu (FIG. 2). This form allows the Level 4 personnel the opportunity to review the request's final response, determine if it meets the original request, and forward the request on for final closure. If the Review Board concurs to close, they may also select to place the request on one of the two lists for further tracking. If they choose to reject the request, an email is provided to the Level 3 Group Lead and Facilitators indicating that further work is required. The database 18 (FIG. 1) is updated accordingly.

If the Level 4 Review Board approves the final response, an email is sent to Level 5 personnel notifying them of this acceptance. The database 18 (FIG. 1) is updated accordingly.

Referring now to FIGS. 10A and 10B, an illustration of a screen view is depicted for Level 5 review of an FSER, which is the Level 5 Final Closure Form. This form is accessible via a hot link in the previous email or via selection of 26 on the Main Menu display shown in FIG. 2. This form allows the Level 5 personnel and the Originator the opportunity to review the request and ensure that it meets the Originator's original request intent. If they concur to close the request, they may also select to place the request on one of the two lists for further tracking. If they reject the final response, an email is provided to the Level 3 Group Lead and the Facilitators indicating that further work is needed. The database 18 (FIG. 1) is updated accordingly. If they accept the final response, an email is sent to all persons (i.e., Level 1 through 4 personnel, the Facilitators and the Originator), then the database 18 (FIG. 1) is updated and the request is closed.

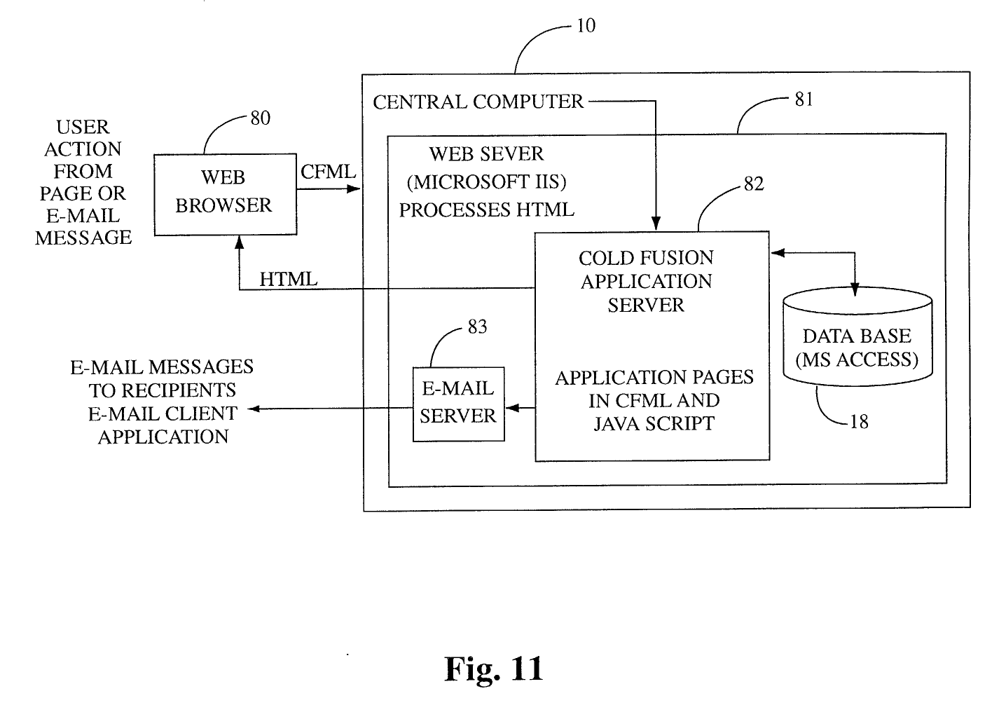

Referring now to FIG. 11, a diagram of the relationship between the central computer 10 and Web Browser software 80 on each of the workstations 11 through 14 (FIG. 1) is shown. Several pieces of standard commercial software are used in the central computer 10 to aid in implementing the above-described process. This software works in conjunction with a web server 81 for the central computer 10. For all page requests and form submittals, all pieces of software perform a specific function and reside on the central computer 10 awaiting a call or on the user's web browser (80). For example, when a request arrives (via a user action) the web server sees a “.cfm” extension on the requesting page. It then forwards the CFML page (i.e., Cold Fusion Markup Language) request to a Cold Fusion application server 82. The Cold Fusion application server parses the requested page, makes any connections to the database 18 that are necessary, updates the database if necessary, generates any necessary email messages; and forwards them to an email server 83. It then returns an HTML page to the web server 81. The web server 81 then serves this page back to the user as a new web page.

The methods and apparatus of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described with reference to a specific embodiment, this description is not meant to be construed in a limiting sense. Various modifications of the disclosed embodiment as well as alternative embodiments of the invention will become apparent to one skilled in the art of web based programming upon reference to the description to the invention. It is therefore contemplated that the appended claims will cover any modifications of the embodiments that fall within the true scope of the invention.

We claim:

1. A method for processing work requests in a system having a central computer containing a web server and a plurality of remote computer workstations coupled to said central computer, said method comprising:
a. an Originator creating a work request at a first of said remote computer terminals and transmitting it to a first level for approval;
b. said first level reviewing said work request and, if approved, transmitting it to a second level Review Board for approval;
c. said second level Review Board reviewing said work request and, if approved, transmitting it to a third level Group Lead for work assignment;
d. a Facilitator assigned in the preceding step executing said work request;
e. said third level Group Lead reviewing work performed by said Facilitators, and transmitting approval to said fourth level if satisfactory;
f. said fourth level Review Board reviewing work performed by said Facilitator, and transmitting it to said fifth level if satisfactory;
g. said fifth level reviewing work performed by said Facilitator and, if satisfactory;
h. closing said work request.

2. The method as in claim 1 wherein said work request is disapproved, notifying said Originator by email through said computer system and canceling said work request.

3. The method as in claim 1 further including the step of transmitting an email message to said Originator each time said work request is approved.

4. The method as in claim 3 wherein said email message includes a hot link to a main menu of said process, thereby providing access to a form for approval of said work request.

5. The method as in claim 1 further including the step of transmitting an email message to the next level in said process each time said work request is approved.

6. The method as in claim 5 wherein said email message includes a hot link to a main menu of said process thereby providing access to a form for approval of said work request.

7. The method as in claim 1 wherein said work performed by said Facilitator is not satisfactory, further including the step of notifying said Facilitator and said Group Lead.

8. The method as in claim 7 further including said Group Lead and employees reworking said work request until the work is approved.

9. The method as in claim 1 further including a main menu displayed for a user to interactively select a step of said process.

10. The method as in claim 10 further including displaying a screen representing an approval form in response to selection of a step of said process from said main menu.

11. A method for processing work requests in a system having a central computer containing a web server and a plurality of remote computer workstations coupled to said central computer, each of said work stations including web browser software, said method comprising:
a. at a first of said remote computer terminals an Originator creating a work request and transmitting it to a first level for approval;
b. said first level receiving an email message requesting a review and approval of said work request and, if approved, transmitting it to a second level Review Board for approval;
c. said second level Review Board receiving an email message requesting a review and approval of said work request and, if approved, transmitting it to a third level Group Lead for work assignment;
d. a Facilitator assigned in the preceding step executing said work request;
e. said third level Group Lead receiving an email message requesting a review and approval of work performed by said Facilitators, and transmitting approval to said fourth level if satisfactory;
f. said fourth level Review Board receiving a request for review and approval of work performed by said Facilitator, and transmitting it to said fifth level if satisfactory;
g. said fifth level reviewing work performed by said Facilitator and, if satisfactory;
h. closing said work request.

12. The method as in claim 11 wherein each of said email messages includes a hot link to a main menu of said process, which provides access to a form for approval of said work request.

13. The method as in claim 11 wherein each of said email messages includes a hot link to a main menu of said process, which provides access to a form for rejecting said work request.

14. The method as in claim 11 wherein a work request is rejected, further including the step of notifying said Originator by email through said computer system and canceling said work request.

15. The method as in claim 11 wherein said work performed by said Facilitator is not satisfactory, further including the step of notifying said Facilitator, said Originator and said Group Lead.

16. The method as in claim 15 further including said Group Lead and Facilitators reworking said work request until the work is approved.

17. The method as in claim 11 further including a main menu displayed for a user to interactively select a step of said process.

18. A method for processing work requests in a system having a central computer containing a web server and a plurality of remote computer workstations coupled to said central computer, each of said work stations including web browser software and said computer executing web server software, said method comprising:
a. an Originator creating a work request at a first of said remote computer terminals and transmitting it to a first level review for approval;
b. said first level receiving an email message requesting a review and approval of said work request and, if approved, transmitting it to a second level Review Board for approval and notifying said Originator by email of said approval;
c. said second level Review Board receiving an email message requesting a review and approval of said work request and, if approved, transmitting it to a third level Group Lead for work assignment and notifying said Originator by email of said approval;
d. a Facilitator assigned in the preceding step executing said work request;
e. said third level Group Lead receiving an email message requesting a review and approval of work performed by said Facilitators, and transmitting approval to said fourth level if satisfactory and notifying said Originator by email of said approval;
f. said fourth level Review Board receiving a request for review and approval of work performed by said Facilitator, transmitting it to said fifth level if satisfactory, and notifying said Originator by email of said approval;
g. said fifth level reviewing work performed by said Facilitator and, if satisfactory;
h. closing said work request and notifying said Originator of closure of said work request.

19. The method as in claim 18 wherein each of said email messages includes a hot link to a main menu of said process, which provides access to a form for approval of said work request.

20. The method as in claim 18 wherein each of said email messages includes a hot link to a main menu of said process, which provides access to a form for rejecting said work request.
